(19) United States
(12) Patent Application Publication
(10) Pub. No.: US 2003/0192061 A1
(43) Pub. Date: Oct. 9, 2003

(54) Set-top box system and method for viewing digital broadcast

(76) Inventors: Seung Hwangbo, Suwon-shi (KR); Nak-Koo Kim, Songnam-shi (KR); Se-Hyuk Oh, Seoul (KR)

Correspondence Address: Robert E. Bushnell, Suite 300, 1522 K Street, N.W., Washington, DC, 20005, US

(21) Appl. No.: 10/384,716

(22) Filed: Mar. 11, 2003

(30) Foreign Application Priority Data
Apr. 3, 2002 (KR) 2002-23711

(51) Int. Cl. H04N 7/20; H04N 7/173; H04N 7/16; H04N 7/12; H04N 11/02; H04N 11/04

(52) U.S. Cl. 725/138; 348/384.1; 725/135; 725/90

(57) ABSTRACT

A set-top box system and method for viewing digital broadcasts. A set-top box system for viewing digital broadcasts includes: a plurality of televisions (TVs); and one set-top box for receiving digital broadcasts including multi-programs, and transmitting single programs selected by program selection requests of TV viewers to the plurality of TVs, the set-top box including: a memory having a program guide database of digital broadcasts; a tuner and demodulator for selecting and demodulating digital broadcasts of a main channel preset in the memory in the received digital broadcasts, and generating the demodulated digital broadcasts as a multi-program transport stream; a controller for controlling each of the sub-channels corresponding to each program selection request of the TV viewers by adopting packetized ID (Identification) information of the multi-program transport stream and the program guide database; a plurality of transport demultiplexers for selecting sub-channels responsive to each program selection request of the TV viewers upon receiving a control signal of the controller, and respectively providing single programs on the selected sub-channels; a plurality of single program decoders for decoding the single programs, respectively; and a transmitter for transmitting the decoded single programs.

### CLAIM OF PRIORITY

This application makes reference to, incorporates the same herein, and claims all benefits accruing under 35 U.S.C. §119 from an application for SET-TOP BOX SYSTEM AND METHOD FOR VIEWING DIGITAL BROADCAST earlier filed in the Korean Industrial Property Office on Apr. 30, 2002 and there duly assigned Serial No. 2002-23711.

### BACKGROUND OF THE INVENTION

1. Field of the Invention

The present invention relates to a communication device, and more particularly to a set-top box system and method for viewing digital broadcasts on many televisions (TVs) by adopting one set-top box.

2. Description of the Related Art

Presently, digital test broadcasting services are now being provided so that the needs for high-quality images or high-quality sound are rapidly increasing. To view digital broadcasts on a current analog television, a user (i.e., a TV viewer) must adapt a set-top box to the current analog television. However, in case of using such a set-top box for viewing digital broadcasts, the user can view the digital broadcasts on only one television.

A conventional one-way RF (Radio Frequency) transmitter/receiver (transmitter and receiver) system has a plurality of RF transmitters and a RF receiver, data received from sources are transmitted to the RF receiver via four channels, and a user is able to watch a television according to the selected one of the four channels. This digital broadcast technology modulates frequency signals based on NTSC (National Television Standard Committee) standards to frequency signals of an ISM (Industrial, Scientific, Medical) band of 2.4 GHz having a bandwidth of 100 kHz, thereby forming four channels. But, each channel is used as a transmission medium of a source having one broadcast data stream generated from a DVD (Digital Versatile Disc player) or a VCR (Video Cassette Recorder).

Since this digital broadcast technology adopts a one-way RF transmitter/receiver system, a TV viewer views a TV broadcast (i.e., a source having one broadcast data) via a channel preset by a RF transmitter on a TV under the condition that a RF receiver selects a corresponding channel. However, another digital broadcast to be provided in the near future may include a plurality of broadcast programs in one source. In this case, each TV viewer using the conventional one-way RF transmitter/receiver system cannot select his or her desired digital broadcast program among many broadcast programs contained in one source.

### SUMMARY OF THE INVENTION

It is therefore an object of the present invention to provide a set-top box system and method for viewing different digital broadcast programs on many TVs by adopting one set-top box.

It is another object to provide an efficient and easy to implement set-top box system and method for viewing different digital broadcast programs on many TVs by adopting one set-top box.

It is yet another object to provide a set-top box system and method for viewing different digital broadcast programs on many TVs by adopting one set-top box that is easy and inexpensive to manufacture.

In accordance with the present invention, the above and other objects can be accomplished by the provision of a set-top box system for viewing digital broadcasts, including: a plurality of televisions (TVs); and one set-top box for receiving digital broadcasts including a multi-program, and transmitting single programs selected according to program selection requests of TV viewers to the plurality of TVs, the set-top box including: a memory having a program guide database of digital broadcasts; a tuner and demodulator for selecting and demodulating digital broadcasts of a main channel preset in the memory in the received digital broadcasts, and generating the demodulated digital broadcasts as a multi-program transport stream; a controller for controlling each of the sub-channels corresponding to each program selection request of the TV viewers by adopting packetized ID (Identification) information of the multi-program transport stream and the program guide database; a plurality of transport demultiplexers for selecting sub-channels responsive to each program selection request of the TV viewers upon receiving a control signal of the controller, and respectively providing single programs on the selected sub-channels; a plurality of single program decoders for decoding the single programs, respectively; and a transmitter for transmitting the decoded single programs.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view illustrating a conventional one-way RF transmitter/receiver system;

FIG. 2 is a conceptual diagram illustrating a set-top box system in accordance with a preferred embodiment of the present invention;

FIG. 3 is a detailed block diagram illustrating a set-top box 30 shown in FIG. 2 in accordance with a preferred embodiment of the present invention;

FIG. 4 is a detailed block diagram illustrating a single program decoder and its peripheral components shown in FIG. 3 in accordance with a preferred embodiment of the present invention;

FIG. 5 is a detailed block diagram illustrating an RF transmitter 34 shown in FIG. 3 in accordance with a preferred embodiment of the present invention;

FIG. 6 is a view illustrating a stream format before and after a signal processing of a transport DEMUX 64-k in accordance with a preferred embodiment of the present invention; and

FIG. 7 is a view illustrating a detailed format of a transport stream on multi-program transport stream in accordance with a preferred embodiment of the present invention.

### DETAILED DESCRIPTION OF THE PREFERRED EMBODIMENTS

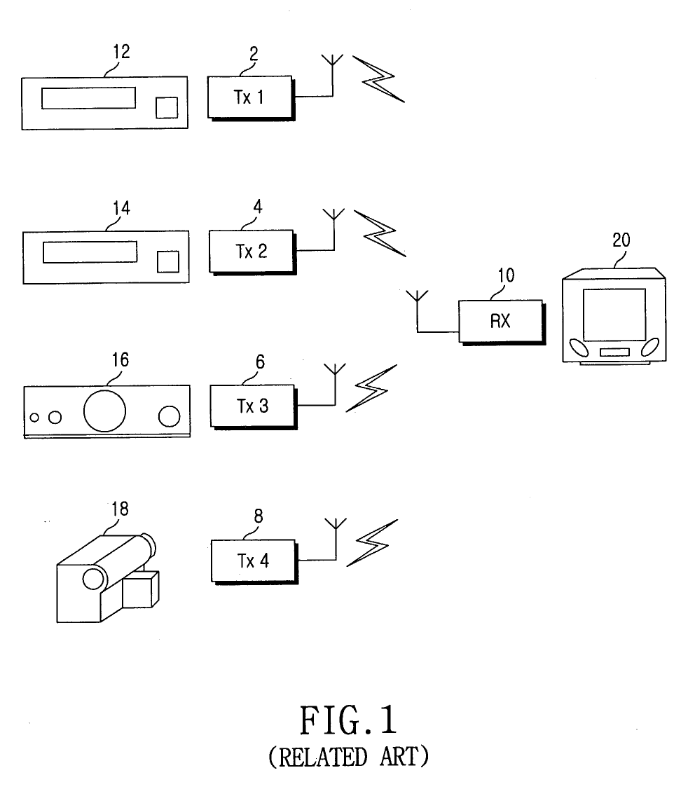

FIG. 1 is a view illustrating an exemplary configuration of a conventional one-way RF (Radio Frequency) transmitter/receiver system. As shown in FIG. 1, in case of using one-way RF transmitter/receiver system having a plurality of RF transmitters 2, 4, 6, and 8 and a RF receiver 10, data received from four sources 12, 14, 16 and 18 are transmitted to the RF receiver 10 via four channels, and a user is able to watch a television 20 according to the selected one of the four channels. This digital broadcast technology modulates frequency signals based on NTSC (National Television Standard Committee) standards to frequency signals of an ISM (Industrial, Scientific, Medical) band of 2.4 GHz (gigahertz) having a bandwidth of 100 kHz (kilohertz), thereby forming four channels. But, each channel is used as a transmission medium of a source having one broadcast data stream generated from a DVD (Digital Versatile Disc player) or a VCR (Video Cassette Recorder).

Since this digital broadcast technology adopts a one-way RF transmitter/receiver (transmitter and receiver) system shown in FIG. 1, a TV viewer views a TV broadcast (i.e., a source having one broadcast data) via a channel preset by a RF transmitter on a TV under the condition that a RF receiver selects a corresponding channel. However, another digital broadcast to be provided in the near future may include a plurality of broadcast programs in one source. In this case, each TV viewer using the conventional one-way RF transmitter/receiver system cannot select his or her desired digital broadcast program among many broadcast programs contained in one source.

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

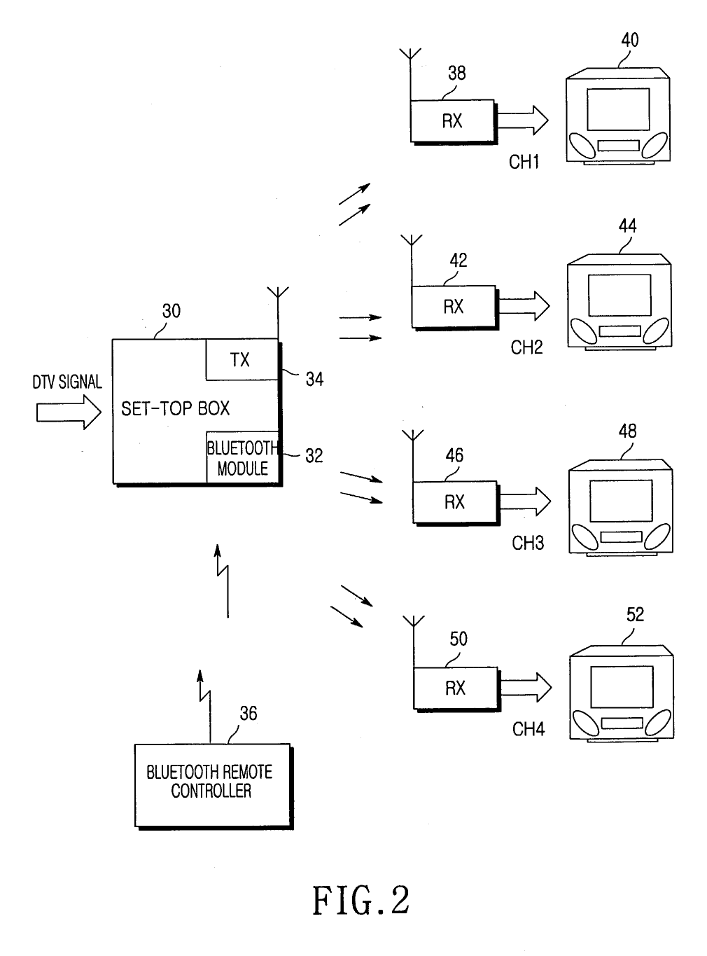

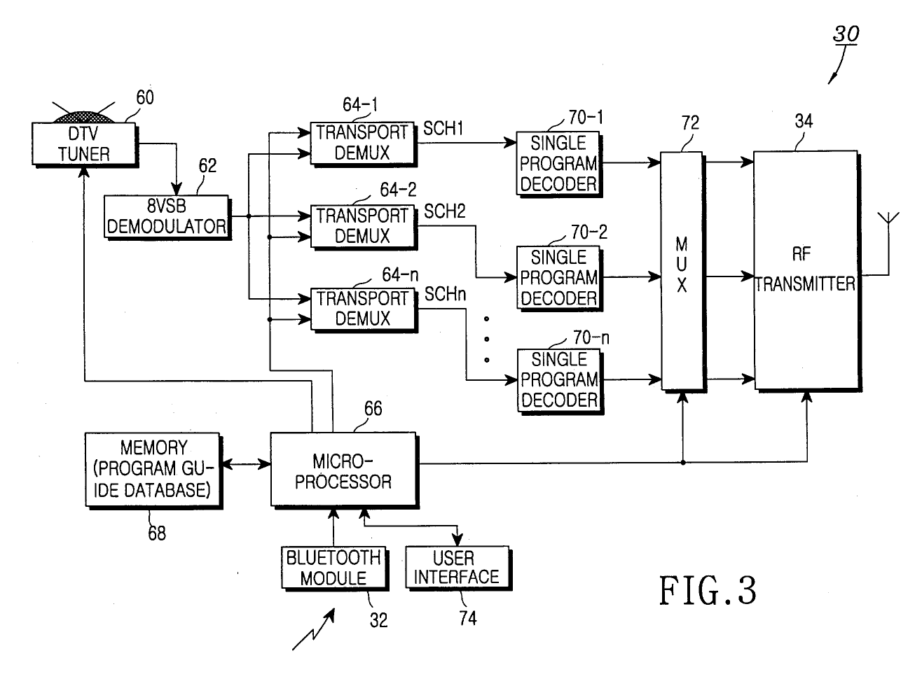

FIG. 2 is a conceptual diagram illustrating a set-top box system in accordance with a preferred embodiment of the present invention, and FIG. 3 is a detailed block diagram illustrating a set-top box 30 shown in FIG. 2 in accordance with a preferred embodiment of the present invention.

Referring to FIG. 2, according to a preferred embodiment of the present invention, one set-top box 30 and a plurality of TVs 40,44, 48 and 52 are installed in a predetermined range from several meters to tens of meters such as a home network area. For example, one set-top box 30 may be installed in a living room at home, and the plurality of TVs 40,44,48 and 52 may be respectively installed in different rooms of a home. The set-top box 30 is newly implemented as shown in FIG. 3 in accordance with a preferred embodiment of the present invention. Referring to FIG. 2, the set-top box 30 includes an RF transmitter 34 for radio-transmitting digital broadcast data to many TVs 40, 44, 48 and 52, a Bluetooth module 32 for making local area radio communication with a Bluetooth remote controller 36 mainly positioned in the vicinity of the plurality of TVs 40, 44, 48 and 52. The plurality of TVs 40, 44, 48 and 52 include corresponding RF receivers 38, 42, 46 and 50, respectively. Also, the TVs 40, 44, 48 and 52 each include a Bluetooth remote controller 36. One TV viewer selects his or her desired sub-channel among a plurality of sub-channels contained in a main digital broadcast channel by adopting the Bluetooth remote controller 36 positioned in the vicinity of a television, and thus views a single program on the selected sub-channel on the TV.

FIG. 2 illustrates a set-top box system for enabling a user to view different digital broadcast programs on many TVs 40, 44, 48 and 52 by adopting only one set-top box 30. Particularly, to enable a user to view different digital broadcast programs on many TVs 40, 44, 48 and 52 by adopting only one set-top box 30 as shown in FIG. 2, a set-top box 30 according to the present invention is implemented as shown in FIG. 3.

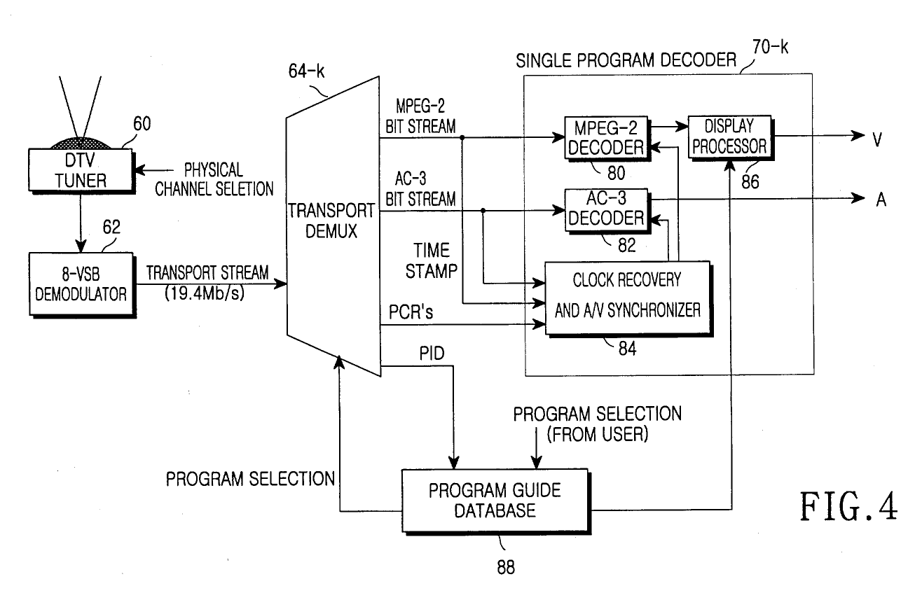

Referring to FIG. 3, the set-top box 30 includes a DTV (Digital Television) tuner 60, an 8-VSB (Vestigial Side Band) demodulator 62, a plurality of transport demultiplexers (DEMUXs) 64-1, 64-2, . . . , 64-n, a microprocessor 66, a memory having a program guide database, a plurality of single program decoders 70-1, 70-2, . . . , 70-n, a multiplexer (MUX) 72, a user interface 74, a Bluetooth module 32, and an RF transmitter 34. A common set-top box includes an NIU (Network Interface Unit), a microprocessor, a memory, an MPEG (Moving Picture Expert Group) decoder, audio/video signal output parts, and a user interface. One example of such common set-top boxes is described in pending U.S. patent application Ser. No. 09/614,709, entitled “Home Network System for Two-way Multimedia Service), assigned to the same assignee as this invention, and also a Korean Patent Application no. 99-28086 filed with Korean Intellectual Property Office prior to a filing date of the U.S. patent application Ser. No. 09/614,709, which are incorporated herein by reference. The DTV tuner 60 and the 8-VSB demodulator 62 may be included in the NIU of the common set-top box. The single program decoders 70-1, 70-2, . . . , 70-n will be described later with reference to FIG. 4, and each decoder includes an MPEG-2 decoder of the common set-top box and an AC-3 (third generation audio coding algorithm, also called DOLBY Digital) decoder.

As shown in FIG. 3, by containing many transport DEMUXs 64-1, 64-2, . . . , 64-n, many single program decoders 70-1, 70-2, . . . , 70-n, a memory 68 having a program guide database in one set-top box 30, a TV viewer can select a desired single program among many multi-programs contained in a digital broadcast source received via one main channel. In other words, one main digital broadcast channel (i.e., one source) includes many sub-channels, but a set-top box system according to a preferred embodiment of the present invention allows a TV viewer to view different sub-channel programs on many TVs 40, 44, 48 and 52, respectively, while using only one set-top box 30. To simultaneously decode a plurality of digital broadcasts (i.e., single programs) on many sub-channels contained in a main channel, it is desirable that the inventive set-top box system includes as many single program decoders 70-k (where, k=1,2, . . . ,n) as sub-channels.

FIG. 4 is a detailed block diagram illustrating a single program decoder 70-k (where, k=1, 2, . . . , n) and its peripheral components shown in FIG. 3. For reference, as shown in FIG. 4, a microprocessor 66 (shown in FIG. 3) between a program guide database 88 and a transport DEMUX 64-k is omitted for the convenience of description and better understanding of the present invention. However, it should be noted that the transport DEMUX 64-k and the program guide database 88 are controlled by the microprocessor 66 as shown in FIG. 3, even though the microprocessor 66 is omitted in FIG. 4.

With reference to FIGS. 3 and 4, in the case where a multi-program MPEG2 TS (Transport Stream) modulated with 8-VSB method, i.e., a digital broadcast signal, is applied to a DTV tuner 60 via an antenna or a cable line, the DTV tuner 60 selects a main channel (denoted as a physical channel in FIG. 4) determined as a basic channel in a memory 68 upon receiving a control signal of the microprocessor 66, and then transmits the selected main channel to a 8-VSB demodulator 62. Herein, a user can select the main channel using a user interface 74 of the set-top box 30. The 8-VSB demodulator 62 demodulates digital broadcast signals received from the DTV tuner 60, and transmits a multi-programmed MPEG2 TS stream (hereinafter referred to as “multi-program transport stream”) to each of many transport DEMUXs (64-1, 64-2, . . . , 64-n) at a bit rate of 19.4 Mbps (megabits per second) for example.

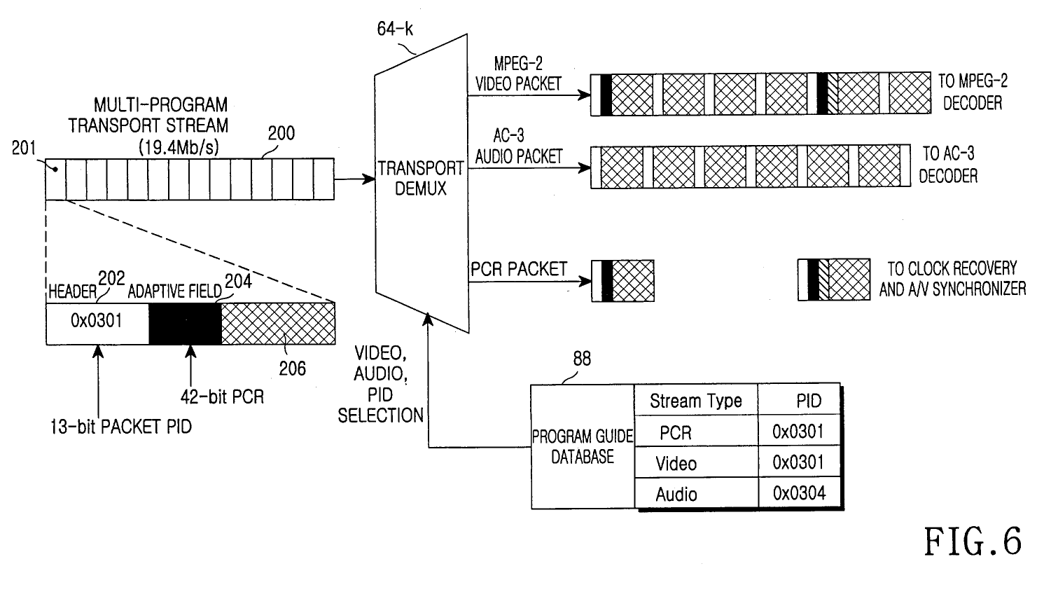

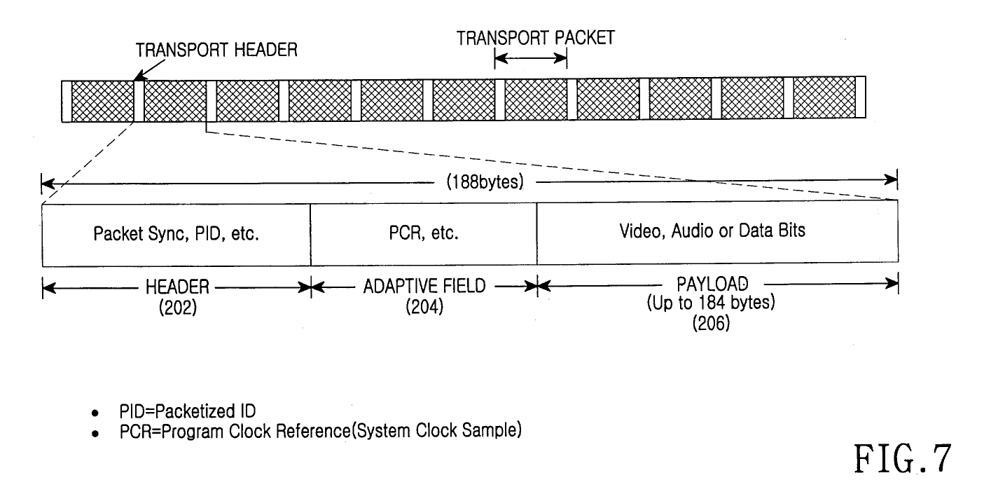

A multi-program transport stream packet structure indicates a configuration standardized by an ITU-T (International Telecommunications Union—Telecommunication) Standardization Sector so as to transport a plurality of programs, and includes transport packets by dividing a typical PES (Packetized Elementary Stream) into many sections (i.e., transport packets). Each transport packet 201 on the multi-program transport stream 200 includes a transport header 202, an adaptive field 204, and a payload 206, as shown FIG. 6. The transport packet 201 of the multi-program transport stream 200 will be described in detail with reference to FIG. 7. The transport header 202 includes a packet synchronous signal, and a PID (Packetized ID) of 13 bits, etc. The adaptive field 204 includes a PCR (Program Clock Reference), etc. The payload 206 includes A/V stream information of sub-channels, that is, audio, video or/and data bit information.

The transport DEMUXs 64-1, 64-2, . . . , 64-n respectively apply a PID of the inputted multi-program transport stream to a program guide database 88 stored in a memory 68 upon receiving a control signal of a microprocessor 66. The microprocessor 66 upgrades the program guide database 88 of the memory 68 configured by a PSIP (Program Specific Information Protocol) by means of the PID. The PSI (Program Specific Information) is defined in an MPEG-2 system standard, and includes a multiplexing content of program streams in a transport stream and network information, etc. Accordingly, the program guide data base 88 is composed of four tables, i.e., a PAT (Program Association Table), a PMT (Program Map Table), an NIT (Network Information Table), and a CAT (Conditional Access Table). The PAT is a table indicating a PID of a corresponding PMT containing information necessary for demultiplexing each program. The PMT is a table containing a PIC of audio and video streams having one program. The NIT is a table containing physical parameters such as FDM frequency and a satellite switching center frequency, etc. The CAT is a table for managing subscribers.

Meanwhile, in the case where a TV viewer who watches a TV program in a room wants to view another digital broadcast program other than a current digital broadcast program by employing a set-top box 30, the TV viewer pushes a broadcast change button using a Bluetooth remote-controller 36 positioned in the room, thereby viewing the desired digital broadcast program on a TV. That is, the TV viewer activates a program selection request signal using the Bluetooth remote-controller 36 positioned in the vicinity of the TV. In the case where the TV viewer requests the Bluetooth remote-controller 36 to change a sub-channel to another sub-channel, channel information corresponding to the requested program and a TV ID (Identification) are transmitted to a microprocessor 66 via a Bluetooth module 32 according to a local area radio communication method. The microprocessor 66 stores a user-desired main channel in a memory 68 as a basic channel via a user interface 74, and receives channel information received from TV viewers in many rooms having therein TVs 40, 44, 48 and 52, respectively, via a Bluetooth module 32. The channel information indicates sub-channel information corresponding to a user-desired broadcast program. Therefore, in the case where the microprocessor 66 receives a TV ID and channel information via a Bluetooth module 32, it controls many transport DEMUXs 64-k to select a MPEG-2 video bit stream of a single program on corresponding sub-channels, AC-3 audio bit stream, and PCR (Program Clock Reference) information by employing the channel information, a PID information on a multi-program stream, and tables of a program guide database 88. Accordingly, each transport DEMUX 64-k (where, k=1, 2, . . . , n) demultiplexes a multi-program transport stream upon receiving a control signal of a microprocessor 66, acquires a MPEG-2 video bit stream of a single program on s different sub-channels preset in the program guide database 88, AC-3 audio bit stream, and PCR information, and then outputs the acquired stream and information to a corresponding single program decoder 70-k (where, k=1, 2, . . . , n). Each single program decoder 70-k (where, k=1, 2, . . . , n) decodes an MPEG-2 video packet and an AC-3 audio packet to be viewed on a TV, and generates a video signal V and an audio signal A of a single program. The single program decoder 70-k (where, k=1, 2, . . . , n) includes an MPEG-2 decoder 80, an AC-3 decoder 82, and a clock restoration and A/V (audio and video) synchronizer 84. The MPEG-2 decoder 80 decodes an MPEG-2 video bit stream and transmits the decoded result to a display processor 86. The display processor 86 processes a video signal decoded by the MPEG-2 decoder 80 according to a user's request signal (e.g., a signal used for adjusting a video resolution), and then generates the processed video signal as a video signal V. The AC-3 decoder 82 decodes an AC-3 audio bit stream, and then generates the decoded result as an audio signal A. The clock restoration and A/V synchronizer 84 receives time stamp information of a MPEG-2 video bit stream and an AC3 audio bit stream, and PCR (Program Clock Reference) information, allows the MPEG-2 decoder 80 and the AC-3 decoder 82 to extract audio and video bit streams, respectively, and controls the MPEG-2 decoder 80 and the AC3 decoder 82 for establishing clock synchronization.

Video signals V and audio signals A of single programs decoded by the single program decoders 70-1, 70-2, . . . , 70-n, respectively are multiplexed by a multiplexer MUX 72 upon receiving a control signal of a microprocessor 66, and are then applied to a RF transmitter 34.

The RF transmitter 34 performs an FM (frequency modulation) modulation on the video signals V and the audio signals A on the basis of channel information received from a TV viewer in each room, thereby loading the signals V and A on each frequency.

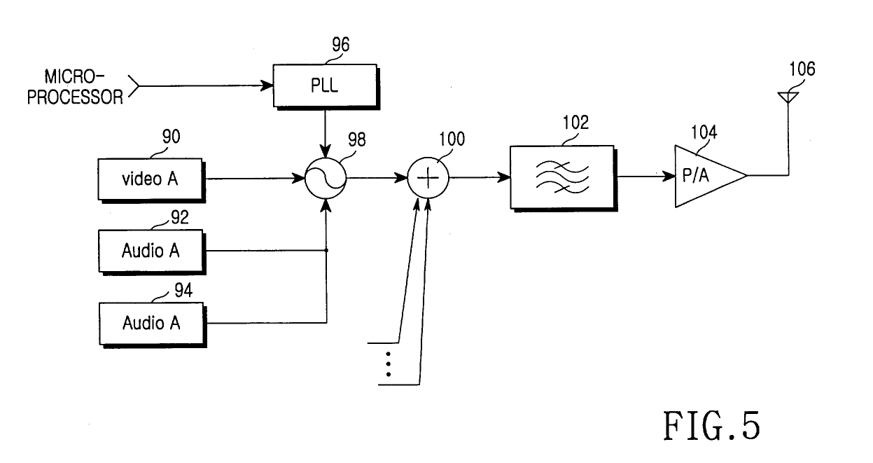

The RF transmitter 34 will be described in detail with reference to FIG. 5. The video signals V and the audio signals A of single programs decoded by many single program decoders 70-1, 70-2, . . . , 70-n include a video A 90 and audio As 92 and 94, as shown in FIG. 5. The video A 90 and the audio As 92 and 94 are applied to an FM modulator 98. Also, a microprocessor 66 controls a PLL (Phase Locked Loop) 96 based on channel information received from each TV viewer in each of the rooms having TVs 40, 44, 48 and 52 and a TV ID, and then transmits a corresponding carrier signal to an FM modulator 98. Therefore, the FM modulator 98 loads the video A 90 and the audio As 92 and 94 on a corresponding carrier signal, and transmits them to a sub-channel mixer 100 as sub-channel FM signals. The sub-channel mixer 100 mixes sub-channel FM signals generated from the FM modulator 98, and then transmits the mixed sub-channel FM signals to a band pass filter (BPF) 102. The mixed sub-channel FM signals generated from the sub-channel mixer 100 are filtered by the BPF 102, a power amplifier (P/A) 104 amplifies powers of the filtered FM signals, and then the amplified signals are radio-transmitted via an antenna 106.

FM receivers 38, 42, 46 and 50 are respectively mounted in different rooms, each FM receiver receiving a predetermined frequency only. The FM receivers 38, 42, 46 and 50 receive output signals generated from the set-top box 30, and FM-demodulate them. Thereafter, a demodulation signal is classified into audio and video signals, and is then applied to corresponding TVs 40, 44, 48 and 52 in such a way that the TVs 40, 44, 48 and 52 receive a single program carried by the sub-channel desired by a TV viewer. As a result, the TV viewer can view his or her desired program on TV.

As apparent from the above description, although the present invention uses one set-top box, it allows a TV viewer to watch different digital broadcast programs on many TVs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A set-top box system for viewing digital broadcasts, comprising:
a plurality of televisions; and
one set-top box receiving digital broadcasts comprised of a multi-program, and transmitting single programs selected by program selection requests of television viewers to said plurality of televisions,
said set-top box comprising:
a memory including a program guide database of digital broadcasts;
a tuner and demodulator selecting and demodulating digital broadcasts of a main channel preset in the memory in the received digital broadcasts, and generating the demodulated digital broadcasts as a multi-program transport stream;
a controller for controlling each of sub-channels corresponding to each program selection request of the television viewers by adopting packetized identification information of the multi-program transport stream and the program guide database;
a plurality of transport demultiplexers selecting sub-channels responsive to each program selection request of the television viewers upon receiving a control signal of said controller, and respectively providing single programs on the selected sub-channels;
a plurality of single program decoders for decoding the single programs, respectively; and
a transmitter for transmitting the decoded single programs.

2. The set-top box system as set forth in claim 1, with said transmitter including a radio frequency transmitter accommodating a mixing of the decoded single programs, and transmitting mixed radio frequency signals to said plurality of televisions.

3. The set-top box system as set forth in claim 1, further comprising:
a local area radio communication remote-controller adjacent to said plurality of televisions, accommodating radio-transmitting channel information responsive to a program selection request of a television viewer and a corresponding television identification information to said set-top box at a proximate distance from said set-top box; and
a local area radio communication unit positioned in said set-top box, receiving television identification information corresponding to the channel information, and providing the received television identification information to said controller.

4. The set-top box system as set forth in claim 2, further comprising:
a local area radio communication remote-controller adjacent to said plurality of televisions, accommodating radio-transmitting channel information responsive to a program selection request. of a television viewer and a corresponding television identification information to said set-top box at a proximate distance from said set-top box; and
a local area radio communication unit positioned in said set-top box, receiving television identification information corresponding to the channel information, and providing the received television identification information to said controller.

5. A method for viewing digital broadcasts using a set-top box system including a plurality of televisions, and one set-top box for receiving digital broadcasts comprising of a multi-program, and transmitting single programs selected according to program selection requests of television viewers to the plurality of televisions, comprising the steps of:
allowing a remote-controller to radio-transmit channel information corresponding to the program selection request and a corresponding television identification information to said set-top box when there is a program selection request from a television viewer present in the vicinity of the televisions;
allowing said set-top box to select and demodulate digital broadcasts of a main channel preset in a memory in received digital broadcasts, generating the demodulated digital broadcast as a multi-program transport stream, selecting sub-channels responsive to the program selection request by adopting the requested channel information, a packetized identification information of the multi-program transport stream, and the program guide database, and providing each of single programs on the selected sub-channels; and
allowing said set-top box to decode each of the provided single programs, radio-transmitting the decoded result signals to the televisions by adopting the corresponding television identification information.

6. The method as set forth in claim 5, with the channel information being sub-channel information corresponding to a desired program of a television viewer.

7. The method as set forth in claim 5, with the remote-controller radio-transmitting the requested channel information and the corresponding television identification information to said set-top box according to a Bluetooth local area radio communication method.

8. The method as set forth in claim 6, with the remote-controller radio-transmitting the requested channel information and the corresponding television identification information to said set-top box according to a Bluetooth local area radio communication method.

9. An apparatus, comprising:
a plurality of first units displaying broadcasts; and
one set-top box receiving broadcasts comprised of a multi-program, and transmitting single programs selected by program selection requests oftelevision viewers to said plurality of first units,
said set-top box comprising:
a memory including a program guide database of the broadcasts;
a tuner and demodulator selecting and demodulating digital broadcasts of a main channel preset in the memory in the received broadcasts, and generating the demodulated broadcasts as a multi-program transport stream;
a controller accommodating a controlling of each of sub-channels corresponding to each program selection request by adopting packetized identification information of the multi-program transport stream and the program guide database;
a plurality of transport demultiplexers selecting sub-channels responsive to each program selection request upon receiving a control signal of said controller, and respectively providing single programs on the selected sub-channels; and
a plurality of single program decoders accommodating a decoding of the single programs, respectively.

10. The apparatus of claim 9, further comprising a transmitter for transmitting the decoded single programs.

11. The apparatus of claim 9, with said transmitter including a radio frequency transmitter accommodating a mixing of the decoded single programs, and transmitting mixed radio frequency signals to said plurality of first units.

12. The apparatus of claim 9, further comprising:
a local area radio communication remote-controller adjacent to said plurality of first units, accommodating radio-transmitting channel information responsive to a program selection request and a corresponding first unit identification information to said set-top box at a distance proximate from said set-top box.

13. The apparatus of claim 12, further comprising:
a local area radio communication unit positioned in said set-top box, receiving first unit identification information corresponding to the channel information, and providing the received first unit identification information to said controller.

14. The apparatus of claim 11, further comprising:
a local area radio communication remote-controller adjacent to said plurality of first units, accommodating radio-transmitting channel information responsive to a program selection request and a corresponding first unit identification information to said set-top box at a distance proximate from said set-top box; and
a local area radio communication unit positioned in said set-top box, receiving first unit identification information corresponding to the channel information, and providing the received first unit identification information to said controller.

15. The apparatus of claim 14, with the number of single program decoders being equal to the number of sub-channels.

16. A method, comprising:
transmitting by a remote-controller channel information corresponding to the program selection request and a corresponding first unit identification information to a single set-top box when there is a program selection request in the vicinity of one of a plurality of first units, the first units accommodating a display of digital broadcasts, the single set-top box receiving the digital broadcasts comprised of multi-programs and transmitting single programs to any first unit of a plurality of first units making the program selection request, said set-top box having a communication link with said plurality of first units;
selecting and demodulating digital broadcasts of a main channel preset in a memory in received digital broadcasts by said set-top box;
generating the demodulated digital broadcast as a multi-program transport stream by said set-top box;
selecting sub-channels responsive to the program selection request by adopting the requested channel information, a packetized identification information of the multi-program transport stream, and the program guide database, and providing each of single programs on the selected sub-channels by said set-top box; and
decoding each of the provided single programs, radio-transmitting the decoded result signals to the first units by adopting the corresponding first unit identification information by said set-top box.

17. The method of claim 16, with the channel information being sub-channel information corresponding to a desired program.

18. The method of claim 16, with the remote-controller transmitting the requested channel information and the corresponding television identification information to said set-top box according to a Bluetooth local area radio communication method.

19. The method of claim 17, with the remote-controller transmitting the requested channel information and the corresponding television identification information to said set-top box according to a Bluetooth local area radio communication method.
